(19) United States
(12) Patent Application Publication
(10) Pub. No.: US 2020/0387789 A1
(43) Pub. Date: Dec. 10, 2020

(54) NEURAL NETWORK TRAINING

(71) Applicant: RISKFUEL ANALYTICS INC., Toronto (CA)

(72) Inventor: Ryan FERGUSON, Toronto (CA)

(21) Appl. No.: 16/894,239

(22) Filed: Jun. 5, 2020

Related U.S. Application Data
(60) Provisional application No. 62/858,025, filed on Jun. 6, 2019.

(51) Int. Cl. G06N 3/08

(52) U.S. Cl. CPC G06N 3/08

(57) ABSTRACT

A low-discrepancy sequence may be used to generate data elements that are applied as a set of training data to a neural network to obtain a trained neural network. Low-discrepancy test data may be applied to a trained neural network to determine an error of the trained neural network with respect to a particular element of the test data. A weight of the particular element of the test data may be adjusted based on the error. Another neural network may be trained with the low-discrepancy test data including the particular element with adjusted weight.

### CROSS-REFERENCE TO RELATED APPLICATION

This application claims the benefit of US provisional application Ser. No. 62/858025, filed Jun. 6, 2019, which is incorporated herein by reference.

### BACKGROUND

Training artificial neural networks may be time consuming and may require a large amount of data. Training data can be very expensive in terms of computational resources. Further, a trained neural network should be tested to ensure that its output is accurate or as expected. As such, older techniques, such as simulations, may be used due to the inability to accurately train a neural network.

### SUMMARY

According to one aspect of this disclosure, a non-transitory machine- readable medium includes instructions to generate data elements according to a low-discrepancy sequence, and apply the data elements as a set of training data to a neural network to obtain a trained neural network.

According to another aspect of this disclosure, a non-transitory machine- readable medium includes instructions to apply low-discrepancy test data to a trained neural network to determine an error of the trained neural network with respect to a particular element of the test data, adjust a weight of the particular element of the test data based on the error, and train another neural network with the low-discrepancy test data including the particular element with adjusted weight.

The above features and aspects may also be embodied as methods, computing devices, servers, and so on.

### BRIEF DESCRIPTION OF THE DRAWINGS

FIG. 1 is a schematic diagram of a computer system to train a neural network.

FIG. 2 shows plots of data generated according to various techniques including low-discrepancy sequences.

FIG. 3 is a schematic diagram of training data and test data for an iterative training process for a neural network.

FIG. 4 is a flowchart of a method of training a neural network using a batch of data.

FIG. 5 is a flowchart of a method of generating a batch of training data.

FIG. 6 is a flowchart of a method of operating a trained neural network.

FIG. 7 is a schematic diagram of an example system to train and operate neural networks.

FIG. 8 shows plots of example data showing adjustment of weights.

### DETAILED DESCRIPTION

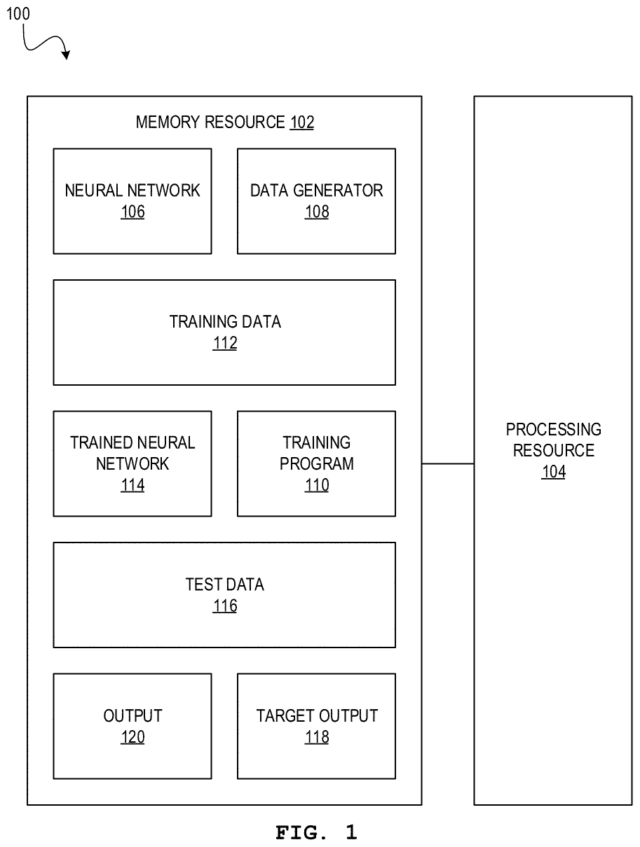

FIG. 1 shows a computer system 100 to train a neural network. The computer system 100 includes a memory resource 102 and a processing resource 104.

The processing resource 104 may include a central processing unit (CPU), a graphics processing unit (GPU), an application-specific integrated circuit (ASIC), a microcontroller, a microprocessor, a processing core, a field-programmable gate array (FPGA), or a similar device capable of executing instructions. The processing resource 104 may cooperate with the memory resource 102 to execute instructions that may be stored in the memory resource 102. The memory may include a non-transitory machine-readable medium that may be an electronic, magnetic, optical, or other physical storage device that encodes executable instructions. The machine-readable medium may include, for example, random-access memory (RAM), read-only memory (ROM), electrically-erasable programmable read-only memory (EEPROM), flash memory, a magnetic storage drive, a solid-state drive, an optical disc, or similar.

The computer system 100 may be a standalone computer, such as a notebook or desktop computer or a server, in which the memory resource 102 and processing resource 104 are directly connected. The computer system 100 may be a distributed computer system, in which any number of network-connected computers may provide a memory resource 102, a processing resource 104, or both.

The memory resource 102 may store a neural network 106, a data generator 108, and a training program 110. The data generator 108 and training program 110 may include instructions that may be executed by the processing resource 104.

The neural network 106 is to be trained to receive input data and output a result. Examples of input data include multi-dimensional numerical data within a set of constraints. For example, input data may include market data, trade specifications, and other numerical values, each constrained to an expected or historic range. The resulting output desired from the neural network 106 may represent a valuation of a financial derivative associated with the inputted values.

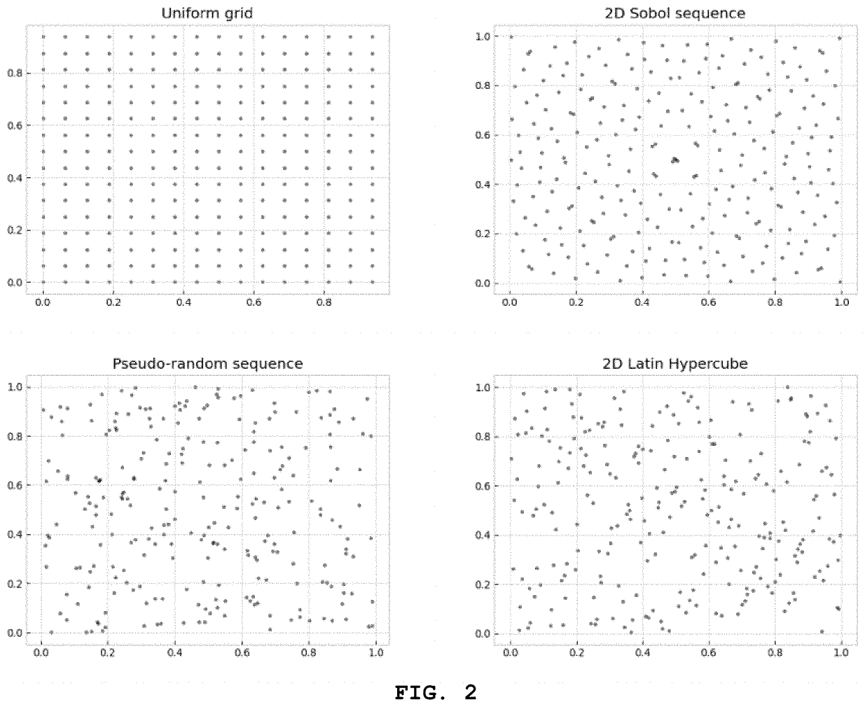

The data generator 108 may be executed by the processing resource 104 to generate a set of training data 112 according to a low-discrepancy sequence. That is, data elements of the training data 112 may be generated to conform to a distribution that increases or maximizes the uniformity of the density of the data elements. Example techniques to generate the low-discrepancy sequence include Sobol, Latin Hypercube, and similar. FIG. 2 shows examples of data elements generated according to Sobol and Latin Hypercube sequences, as compared to a grid or a pseudo-random case. The data elements of the low-discrepancy sequences are not regularly distributed, such as in a grid-like arrangement, but are more uniformly distributed than in the pseudo-random case.

The training program 110 applies the set of training data 112 to the neural network 106 to obtain a trained neural network 114. The training program 110 may also initialize and configure the neural network 106 prior to applying the set of training data 112. Multiple different neural networks 106 may be trained at approximately the same time, in parallel. Such different neural networks 106 may have different architectures, quantities/arrangements of neurons, and/or different initial conditions.

The memory resource 102 may further store a set of test data 116 and target output 118. The target output 118 represents an expected or accepted output for the purpose of the trained neural network 114. For example, target output 118 may include accepted valuations of a financial derivative for various inputs, such as market data, trade specifications, etc. Such target output 118 may be generated by an established technique, such as a Monte Carlo simulation, finite difference methods, binomial trees, etc. The technique used to generate the target output 118 need not be known to the computer system 100. An established technique may be used with parameters unknown to the computer system Dm. The target output 118 may be provided by another entity or computer system that is secured against obtaining knowledge of the underlying technique used to generate the target output 118. The technique used to generate the target output 118 may be unknown or proprietary.

The processing resource 104 may apply the set of test data 116 to the trained neural network 114 to obtain output 120 of the trained neural network 114. The processing resource 104 may further compare the obtained output 120 to the target output 118. If the output 120 differs from the target output 118 by more than a fidelity threshold, then the processing resource 104 may discard the trained neural network 114. If the output 120 does not differ from the target output 118 by more than the fidelity threshold, then the trained neural network 114 may be accepted as fit for purpose. Comparing the output 120 to the target output 118 may include evaluating an error function.

The set of test data 116 may be generated by the same data generator 108 that generated the set of training data 112. As such, the set of test data 116 may conform to the same low-discrepancy sequence. After generation of the set of training data 112 using the low-discrepancy sequence, the processing resource 104 may continue to apply the low-discrepancy sequence to generate data elements for the set of test data 116. That is, the training data 112 and the test data 116 may be subsets of the same set of data elements generated according to the low-discrepancy sequence.

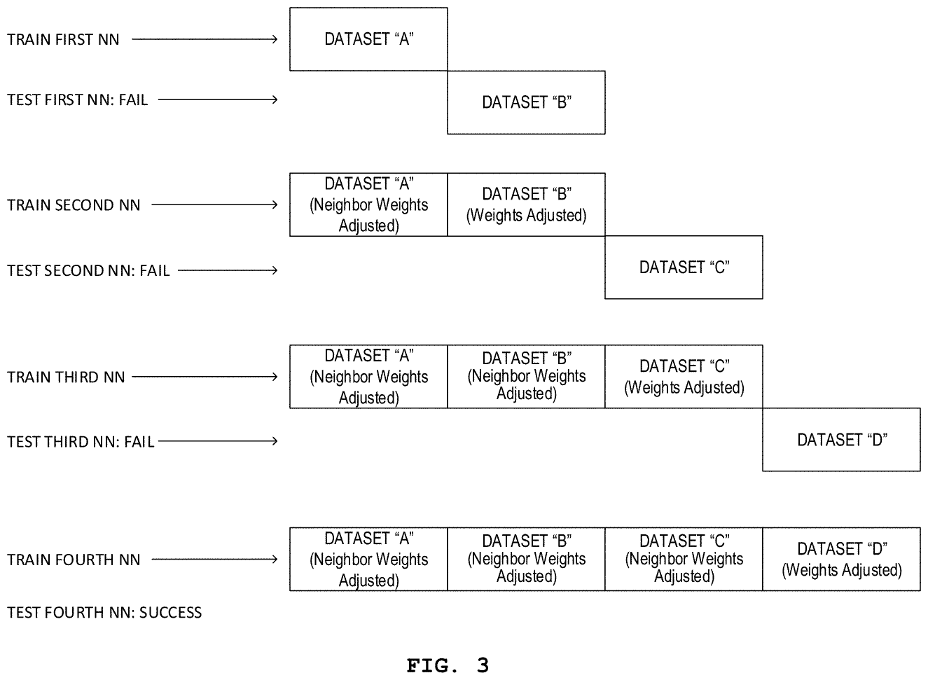

If the trained neural network 114 is discarded due to lack of fidelity to the expected or accepted output, then another neural network 106 may be trained, as discussed above, using a second set of training data 112 to obtain a second trained neural network 114. This other neural network 106 may have a different architecture, quantity/arrangement of neurons, and/or different initial condition than the original neural network used to generate the discarded trained neural network 114. The second set of training data 112 may include the original set of training data 112 used to train the discarded neural network 114 and the set of test data 116. That is, the second neural network 106 is trained with former test data repurposed as training data. The resulting second trained neural network 114 may be evaluated based on further generated test data 116. If the second trained neural network 114 is discarded, then such test data may be used to train a third neural network 106, and so on, until a trained neural network 114 meets the fidelity threshold. That is, subsequent sets of test data may be included in the set of training data for subsequent applications of training data to a neural network until a trained neural network is not discarded. A neural network that is trained and tested may be referred to as a candidate neural network until it is accepted or discarded. The above-described process is summarized in the sequence shown in FIG. 3.

With reference to FIG. 3, the sizes of the datasets may be the same or different. For example, test dataset “C” may be the same size as combined training dataset “A″+”B″. Likewise, dataset “D” may be the same size as datasets “A”, “B”, and “C” combined. In another example, each of datasets “A” through “D” may be the same size. As will be discussed below, a weight of a data element in a test dataset that is subsequently used for training may be adjusted based on the error in that data element as tested, as indicated in the figure by “Weights Adjusted.” Further, a neighbor data element that is near a weight-adjusted test data element may also have its weight adjusted. Such a neighbor data element may be in the test data or may be in the training data, as indicated by “Neighbor Weights Adjusted” in the figure. In addition or as an alternative to adjusting weights, data elements may be provided with increased concentration in regions where error is determined. Error at a data element may signify that an insufficient number of data elements exists near that element. Hence, density of data elements may be increased around data elements tested to have high error.

Errors observed when applying the test data 116 may be attributed to individual test data elements. Subsequently, this test data 116 may be repurposed as training data 112, and the errors may be used to apply a weighting to the training data 112. Training data 112 is weighted so that it may have a greater effect on the training of the neural network 106. Increasing weighting of particular data elements provides bias to the error function towards minimizing error at these particular data elements. Further, it should be noted that increasing a weight of an erroneous data element may instead be achieved by holding its weight constant and decreasing weights of non-erroneous data elements.

An example of a weighting strategy is to apply a weight proportional to the observed error. Another example strategy is to weight datapoints associated with errors greater than the average error with a weight of one, and to weight the datapoints associated with errors less than the average with a weight of zero. This may result in placing additional training data only in areas where performance is below average.

Also, for each test datapoint, a number of its near neighbors may be obtained. The near neighbors may be the nearest neighbors or they may be constrained to be approximate to reduce the time to obtain them (that is, the rigorous nearest neighbors are not required). The near neighbors may be provided with adjusted weights. The near neighbors may be determined from the set of all datapoints. That is, data elements in test data may have weights adjusted based on their errors, and near neighbor data elements in both test and training data may also have their weights adjusted.

The data generator 108 may be used to determine the near neighbors. As each datapoint is generated (using LDS), we update the near neighbors for the datapoint and all previously generated datapoints. Any suitable algorithm to compute near neighbors may be used. For example, near neighbors may have input values that are proximate within a specified amount or tolerance. A k-nearest neighbors (k-NN) technique may be used.

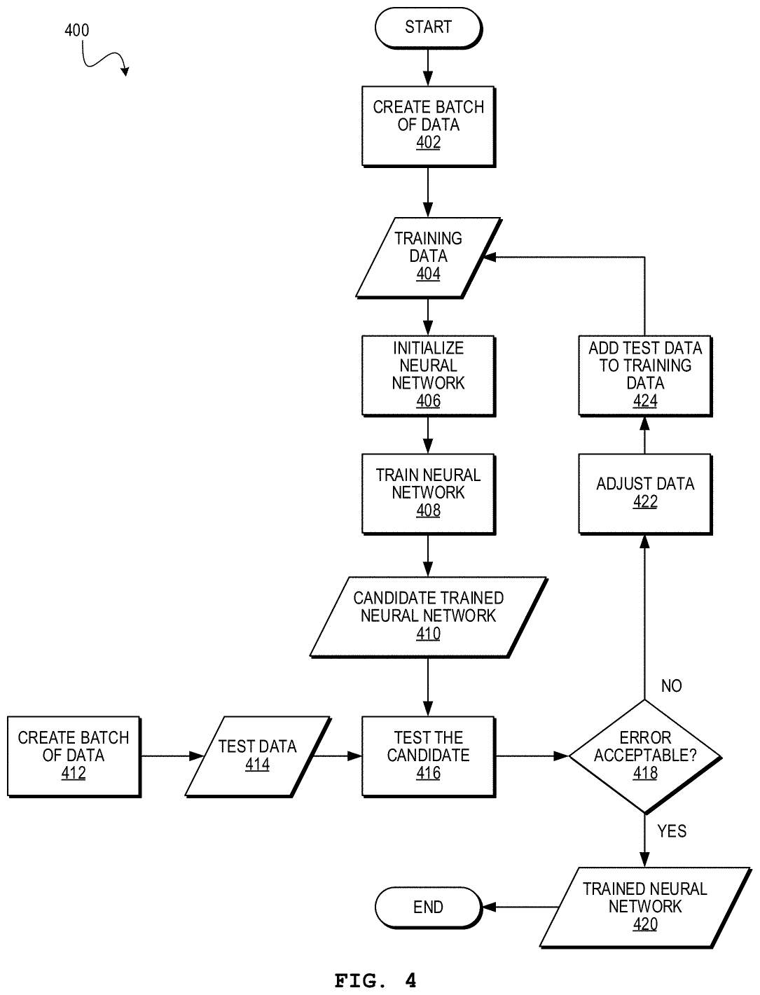

With reference to FIG. 4, a method 400 may take a batch of training data to train one or more neural networks, which may be configured and/or initialized differently. The method 400 may be implemented with instructions executable by a processing resource. A neural network may be tested using a batch of test data, which may include training data from an earlier cycle of training and testing. The test may compute an error. If the error is acceptable, then the relevant neural network(s) may be saved and put into production to generate results using real data. If the error is unacceptable, then the relevant neural network(s) may be discarded. Test data may then be weighted, such as by applying weights to test data elements based on respective individual errors of such data elements. The near neighbors of adjusted test data, whether in the test data or in the existing training date, may also be weighted. The test data may be incorporated into the training data for use in the next cycle of the method to train one or more new neural networks.

In addition or as an alternative to adjusting weights, a concentration of data elements may be increased around a particular data element that had a high degree of error during a test. For example, instead of increasing the weight associated with a data element from 1.0 to 3.0, two more data elements may be added in the same location each with a weight of 1.0. A modification of this strategy would result in the additional data elements being placed close to the original data element, but not at precisely the same location. The locations of the new data elements may be determined using low-discrepancy sequences, pseudo-random data generation, or other appropriate techniques.

Neural networks that are trained and tested may be referred to as candidates. Any number of candidate neural networks may be trained and tested according to any suitable regimen. In the example of FIG. 4, candidate neural networks may be trained, tested, and discarded if error is unacceptable, until the candidate neural network under consideration provides acceptable error. The successful candidate neural network may then be put into production.

At block 402, a batch of training data 404 is generated according to a low-discrepancy sequence, such as a Sobol or Latin Hypercube sequence, as discussed elsewhere herein. A batch of data may be generated as needed or in advance. In addition, data elements of the batch may be given initial weightings, such as weights of 1.

At block 406, a neural network is configured and initialized. The hyper-parameters such as number of nodes and number of hidden layers are set and the parameters such as the node weights are initialized. The neural network may have parameters and hyper-parameters with values that are different from the previous cycle of method 400.

At block 408, the neural network is trained using the training data 404 to become a candidate trained neural network 410 to be tested and then discarded or put into use.

At block 412, a batch of test data 414 is generated according to a low-discrepancy sequence. This may be done using the same process as block 402. The batch of test data 414 may be obtained from the continued execution of the process that generated the batch of training data 404. Subsequent batches of test data 414 may be obtained from the continued execution of the same process. As discussed elsewhere herein, the batch of test data 414 may subsequently be used as training data.

At block 416, the candidate trained neural network 410 is tested using the test data 414. This may include taking an output of the candidate trained neural network 410 and computing an error from the expected output. An error function may be evaluated. Total error may be considered, so that the neural network under test may be discarded if it is generally unsuitable. Error of individual data elements may be considered, so that the neural network under test may be discarded if it contains one or few regions of high error. A trend in error may be considered, so as to efficiently eliminate a candidate to avoid further training that is unlikely to result in an acceptable neural network. Further, data elements of the test data 414 with a high degree of error may be identified.

At block 418, the error of the candidate trained neural network 410 is determined to be acceptable or unacceptable. A fidelity threshold may be used. If the error is acceptable, then the candidate trained neural network 410 may be taken as the trained neural network 420 and be put into production. The method 400 may then end.

If the error is unacceptable, then the candidate trained neural network 410 may be discarded, at block 406.

Further, in preparation for another cycle of the method 400 with another candidate neural network, the data is adjusted, at block 422. This may include increasing weightings of test data elements determined to have a high degree of error (at block 416), so as to bias the error function to reduce or minimize error at these high-error data elements. Weightings of near-neighbor data elements, whether in the test data 414 or in the training data 404, may also be increased. At block 424, the test data 414 may be combined into the training data 404, so that the next candidate neural network is trained with more data. In one example, high-error datapoints in the test data 414 are identified, the test data 414 is combined with the training data 404 to form a larger set of training data 404, and then the high-error datapoints and their near neighbors (both contained in the larger set of training data 404) have their weights adjusted. In addition or as an alternative to adjusting weights, a concentration of data elements may be increased around a particular data element that had a high degree of error during a test. For example, instead of increasing the weight associated with a data element from 1.0 to 3.0, two more data elements may be added in the same location each with a weight of 1.0. A modification of this strategy would result in the additional data elements being placed close to the original data element, but not at precisely the same location. The locations of the new data elements may be determined using low-discrepancy sequences, pseudo-random data generation, or other appropriate techniques. These additional data elements may be combined into the training data 404, so that the next candidate neural network is trained with more data.

The method 400 then continues by initializing and training the next candidate neural network, at blocks 406, 408.

The method 400 may be repeated until a candidate trained neural network meets the error requirements, at block 420. Multiple instances of the method 400 may be performed simultaneously, so that multiple candidate neural networks may be trained and tested at the same time. All such instances of the method 400 may be halted when one of the candidates from any instance of the method 400 meets the error requirements. Further, multiple instances of the method 400 may share the same data 404, 414.

The below example Python code provides an example implementation of blocks of the method 400, with comments and blocks identified inline:

# Setup the training data. x is input data; y is output data.
# This is to train the network to learn the function that maps x onto y
# Training data may be generated using a low discrepancy sequence.
# This approximately corresponds to blocks 402, 404
train_x, train_y = load_train_data( )
# Setup the default/initial weighting of training data
# In this example, the initial weights are set to 1.0
train_x_weights = torch.ones(train_x.size( ))
# Select error/loss function for determining global fitness of neural
# network. In this example, Mean Squared Error (MSE) is used
train_loss_fn = torch.nn.MSELoss( )
test_loss_fn = torch.nn.MSELoss( )
# Select methodology for changing the neural network parameters via
# training. In this example Adaptive Moment Estimation (Adam) is used
optimizer = optim.Adam(neural_net.parameters( ))
while continueTraining:

# Initialize neural network. Similar to block 406.
neural_network = initialize_neural_network( )
# Train the neural network. Similar to block 408.
while continueTrainingStep :

# Predict a value for y for each x in the training data
train_y_pred = neural_network(train_x_)
# Calculate the error/loss for each training data element
raw_train_error = train_loss_fn(train_y_pred, train_y_)
# Apply the training data weighting
weighted_train_error = train_error * train_x_weights
# Adjust neural network parameters to reduce the
# error/loss in subsequent predictions
weighted_train_error.mean( ).backward( )
optimizer.step( )
if (trainingStepStopCriterion( ) == True) :

# Candidate trained network is ready
# for evaluation. Similar to block 410
break

# Once a round of training is done, test data is used to
# assess the ability of the neural network to predict
# correctly on data it hasn't been trained on.
# This is similar to block 414.
test_x, test_y = load_test_data( )
test_y_pred = neural_network(test_x)
# Test candidate trained neural network by applying
# this data to the network and calculate error/loss.
# Similar to block 416.
test_error = test_loss_fn(train_y_pred, train_y)
if (trainingStopCriterion(test_error) == True) :

# The error is acceptable, so this is the
# Trained Neural Network (blocks 418, 420)
break

# If not, adjust the training data in preparation
# for the next iteration. Similar to block 422.
# In this example, the training data weights are adjusted
# to make them proportional to the error/loss observed
train_x_weights = concatenate(train_x_weights,
constant_of_proportionality * test_error)
# Then, the next set of training data is created by
# combining the test data with the existing training data,
# as similar to block 424.
train_x = concatenate(train_x, test_x)
train_y = concatenate(train_y, test_y)

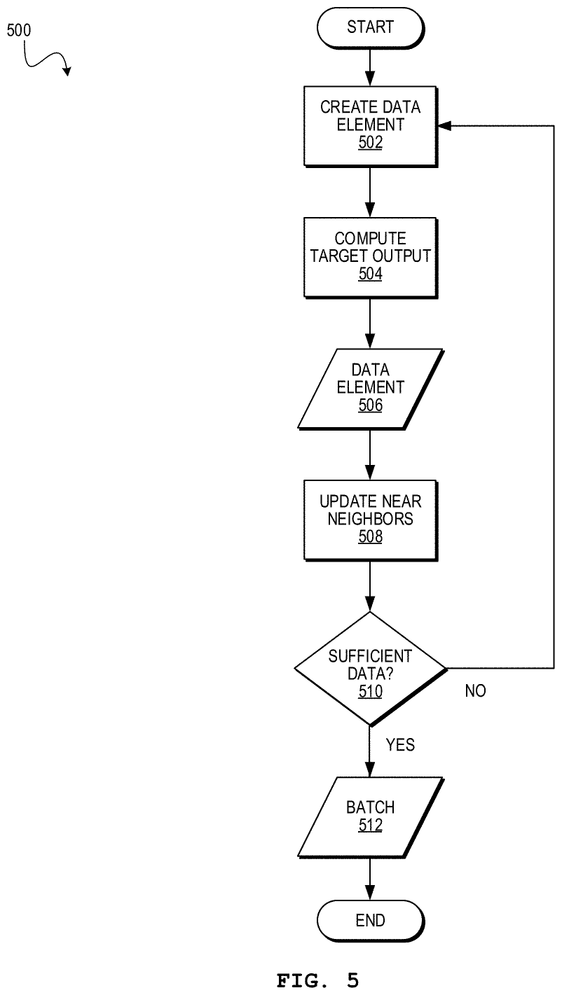

As shown in FIG. 5, a method 500 of generating data elements may use a low-discrepancy sequence and may determine near neighbors, so as to generate a batch of training/test data. The method 500 may be implemented with instructions executable by a processing resource.

At block 502, a data element 506 is created using a low-discrepancy sequence, as discussed elsewhere herein. The data element 506 may be provided with an initial weighting of 1. The data element 506 may be a multi-dimensional datapoint.

At block 504, a target output is computed for the data element 506. The target output may be generated by an established technique and/or may indicate an expected output value for the data element. The data element 506 therefore correlates any number of inputs (dimensions) to a target output.

At block 508, near neighbor data elements, if any, are determined for the data element 506. That is, the input values of the data element 506 are compared to the input values of all other data elements already generated to determine which data elements, if any, the present data element 506 is near. The data element 506 is associated with its near neighbors.

The data element 506 is added to the batch 512 and if the batch 512 is now of a sufficient size, then the method 500 ends. The method 500 may generate data elements 506 until the batch 512 complete.

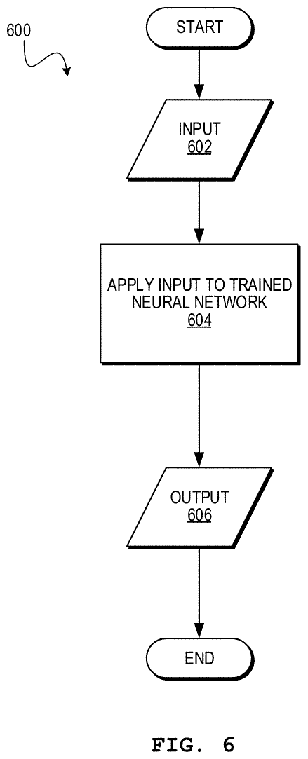

As shown in FIG. 6, a method 600 of operating a trained neural network may operate on a request that includes input parameters. An output may be returned The method 600 may be implemented with instructions executable by a processing resource.

At block 602, a request may be received in the form of input values or parameters.

At block 604, an output or result (which in a finance implementation may be a price or currency amount) may be determined. To obtain the output, the received input values may be applied to the trained neural network.

At block 606, the output may be returned in response to the request at block 602.

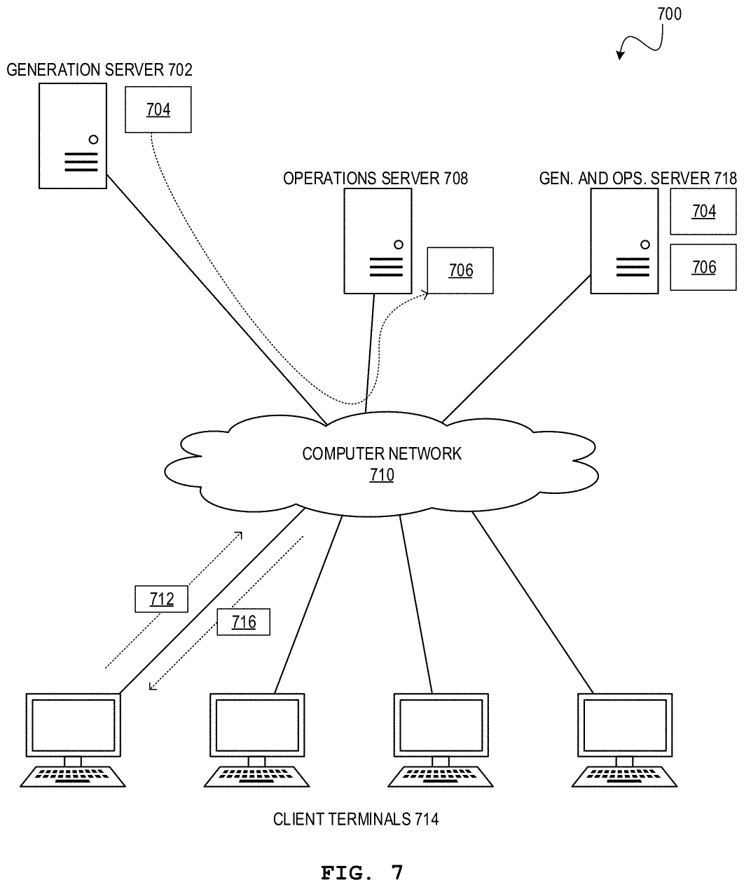

FIG. 7 shows an example system 700 in which neural networks may be trained and operated. The system 700 may implement any of the techniques discussed above.

The system 700 may include a generation server 702 configured with instructions 704 to generate data and train neural networks as discussed elsewhere herein. The generation server 702 may include processing and memory resources to store and execute the instructions 704. Once a neural network 706 is trained, the neural network 706 may be deployed to an operations server 708 via a computer network 710, such as the internet.

The operations server 708 may include processing and memory resources to store and execute the trained neural network 706. The operations server 708 may receive requests 712 from client terminals 714, apply such requests 712 to the trained neural network 706 to obtain results 716, and respond to the requesting client terminals 714 with such results 716.

Additionally or alternatively, a generation and operations server 718 may include processing and memory resources configured with instructions 704 to generate data and train neural networks as discussed elsewhere herein, and further may operate a trained neural network 706 to receive requests 712 from client terminals 714 and respond with results 716.

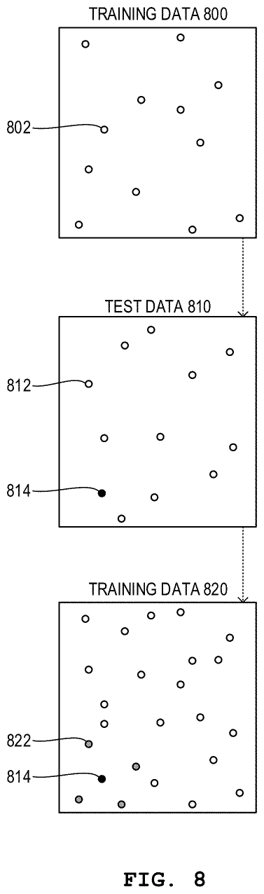

FIG. 8 shows an example of the combining of test data with training data and the weighting of erroneous and near neighbor data elements. A training dataset Boo is created by generating data elements 802 using a low-discrepancy sequence. The training dataset is used to train a neural network. A test dataset 810 is created by generating data elements 812 using the low-discrepancy sequence. Generation of the test dataset 810 may be a continuation of the process used to generate the training dataset 800, so that all data elements 802, 812 are part of the same low-discrepancy sequence. The test dataset 810 is used to test the trained neural network by comparing output of the neural network in response to the test dataset 810 to an established or expected output. An error function may be evaluated to decide whether or not to accept the trained neural network. If the network is not accepted, it is discarded and a particular data element 814 (heavy shading) with a high degree of error may be identified for weight adjustment. Any number of high-error data elements 814 may be identified. The test dataset 810 may be combined with the training dataset Boo to form an updated training dataset 820 that includes the data elements 802, 812 from each and thereby conforms to the low-discrepancy sequence. The high-error data element 814 and neighboring data elements 822 (light shading) near the high-error data element 814 may have their weights adjusted, so that a next neural network to be trained is trained in a way that specifically accounts for error witnessed in the discarded neural network. The training dataset 820 is used to train the next neural network, which is tested with newly generated test dataset 810. If testing fails, then the test dataset 810 is combined with the training dataset 820, as discussed above, with weight adjustments being made to data elements 814 that gave high error on test and their neighbor data elements 822.

In view of the above it should be apparent that a neural network may be trained in an efficient and accurate manner using low-discrepancy data, iteratively adjusted weightings based on error, and recycling of test data into training data. The time and processing resources required in training and deploying a neural network may be reduced.

What is claimed is:

1. A non-transitory machine-readable medium comprising instructions to:
generate data elements according to a low-discrepancy sequence; and
apply the data elements as a set of training data to a neural network to obtain a trained neural network.

2. The non-transitory machine-readable medium of claim 1, wherein the instructions are further to:
continue to generate additional data elements according to the low-discrepancy sequence;
apply the additional data elements as a set of test data to the trained neural network to obtain an output of the trained neural network;
compare the output to a target output; and
discard the trained neural network if the output differs from the target output by more than a fidelity threshold.

3. The non-transitory machine-readable medium of claim 2, wherein the instructions are to:
apply the set of test data to the trained neural network to obtain a corresponding output for each additional data element; and
compare each corresponding output of the trained neural network to a corresponding target output.

4. The non-transitory machine-readable medium of claim 2, wherein the instructions are to compare the output to a target output by evaluating an error function.

5. The non-transitory machine-readable medium of claim 2, wherein the target output is generated by a simulation.

6. The non-transitory machine-readable medium of claim 2, wherein the instructions are further to, if the trained neural network is discarded, apply a second set of training data to another neural network to obtain a second trained neural network, wherein the second set of training data includes the set of training data and the set of test data.

7. The non-transitory machine-readable medium of claim 6, wherein the instructions are further to include subsequent sets of test data in the set of training data for subsequent applications of the training data to the neural network until the trained neural network is not discarded.

8. The non-transitory machine-readable medium of claim 6, wherein the instructions are further to:
obtain an error for a particular data element of the set of test data with respect to the target output for the particular data element; and
apply a weight to the particular data element based on the error when applying the particular data element to the neural network as part of the second set of training data.

9. The non-transitory machine-readable medium of claim 8, wherein the instructions are further to:
apply a weight to a near-neighbor data element of the particular data element based on the error when applying the near-neighbor data element to the neural network as part of the second set of training data.

10. The non-transitory machine-readable medium of claim 6, wherein the instructions are further to:
obtain an error for a particular data element of the set of test data with respect to the target output for the particular data element; and
increase a concentration of data elements of the second set of training data around the particular data element based on the error.

11. The non-transitory machine-readable medium of claim 9, wherein the instructions are further to:
identify the near-neighbor data element when generating the particular data element.

12. The non-transitory machine-readable medium of claim 1, wherein the instructions are to simultaneously apply the data elements as the set of training data to a plurality of neural networks to obtain a plurality of trained neural networks.

13. The non-transitory machine-readable medium of claim 1, wherein the low-discrepancy sequence includes a Sobol sequence, a Latin Hypercube sequence, or a combination thereof.

14. The non-transitory machine-readable medium of claim 1, wherein the data elements are constrained based on a financial derivative, and wherein the trained neural network is to compute a value of the financial derivative.

15. A non-transitory machine-readable medium comprising instructions to:
apply low-discrepancy test data to a trained neural network to determine an error of the trained neural network with respect to a particular element of the test data;
adjust a weight of the particular element of the test data based on the error; and
train another neural network with the low-discrepancy test data including the particular element with adjusted weight.

16. The non-transitory machine-readable medium of claim 15, wherein the instructions are further to adjust a weight of a neighbor element that is near the particular element based on an error of the neighbor element determined from the trained neural network.
